(19) United States
(12) Patent Application Publication
(10) Pub. No.: US 2015/0057796 A1
(43) Pub. Date: Feb. 26, 2015

(54) Snack and Food Dispenser for Commercial Aircraft Use

(71) Applicant: Lillian Boodaghians, La Crescenta, CA (US)

(72) Inventor: Lillian Boodaghians, La Crescenta, CA (US)

(21) Appl. No.: 14/462,566

(22) Filed: Aug. 19, 2014

Related U.S. Application Data
(60) Provisional application No. 61/869,766, filed on Aug. 26, 2013.

(51) Int. Cl. B64D 11/00; G07F 11/10

(52) U.S. Cl. CPC B64D 11/0007; G07F 11/10
USPC 700/236; 244/118.5

(57) ABSTRACT

Embodiments of the present invention provide snack and food dispensers on passenger transport vehicles, particularly aircraft, that will ensure fair distribution of self-serve snacks provided between meals and/or during flight in an organized, systematic, safe, and sanitary manner as well as allow a more accessible means for buying “Food for Purchase” items with less crew dependence for serving.

### CROSS REFERENCE TO RELATED APPLICATIONS

This application claims the benefit of U.S. Provisional Application Ser. No. 61/869,766 filed on Aug. 26, 2013, titled “Snack and Food Dispenser for Commercial Aircraft Use,” the entire contents of which are hereby incorporated by reference.

### FIELD OF INVENTION

Embodiments of the present invention relate generally to snack and food dispensers on passenger transport vehicles, particularly aircraft, that will ensure fair distribution of self-serve snacks provided between meals and/or during flight (depending on flight length and time) in an organized, systematic, safe and sanitary manner as well as allow a more accessible means for buying “Food for Purchase” items with less crew dependence for serving.

### BACKGROUND OF INVENTION

Airlines often provide complimentary self-serve snacks on board flights, between meals. Currently, airlines that provide this service, usually on long-haul flights, place snacks in the galley in an open box or in an open galley fixture during the course of the flight, usually before and/or after passengers have been served dinner or lunch, depending on the time of day. The snacks provided are available on a first come, first served basis when the snack carton/plastic box is positioned on top of the galley counter. Sometimes the snack/carton container is put on top of a trolley and is pushed up and down the aisle by the crew. In either situation, the set-up allows passengers to take and/or ask for as many or as few snacks as they please, it also means crew members handle snacks before giving them to passengers and/or passengers are allowed to touch any number of the snacks before choosing which snack to take, depending on the method of service offered on board the aircraft.

Airlines, particularly low-cost or no frills airlines, also often offer “Food for Purchase” items on board flights, as do other airlines on flights with shorter duration. Purchases of these items can only be made by passengers at the few times on the flight where crew members bring the trolleys down the aisle, usually around meal times. The purchase involves direct transfer of payment between passenger and flight attendant and therefore requires a flight attendant to be present and available each time a purchase is made.

### BRIEF SUMMARY OF INVENTION

Embodiments of the invention provide a means for airlines to manage the supplies they carry on the plane so that all passengers can claim their fair portion of onboard refreshments in an organized and sanitary manner through the use of an automated and/or semi-automated snack and food dispenser, depending on the actual design. They also provide a means for passengers to buy “Food for Purchase” items on board flights where complimentary food is not provided. These dispensers are designed to meet the relevant regulatory requirements for airworthiness. They will be located mainly in galleys and stowed in tandem food trolleys, making use of space currently occupied by carton boxes containing the snacks/food. Equally, the dispenser can be stored in the less productively used dead space behind the trolley, depending on the galley configuration. The dispenser can also potentially replace some of the food trolleys in a given galley configuration or, equally, be placed in a separate/other galley compartment.

The application will allow for more efficient and effective snack/food dispersal, preventing certain passengers from taking an exorbitant number of complimentary snacks while other passengers are unable to claim their share by allowing airlines to place limits on the number of snacks a passenger can claim and also track how many snacks passengers retrieve. It will also allow for purchase of extra refreshments. The dispenser will eliminate the need for airlines to carry excess food on board to compensate for the uneven distribution of refreshments, thereby reducing both food and fuel costs via weight saving on food/snack related items and allowing the airline operator to better manage costs associated with providing passengers with snacks.

Currently, there are no effective and passenger/crew friendly dispensing systems used on aircraft. While there are airlines that allow for the purchase of food items onboard a flight, particularly low-cost or no-frills airlines, these purchases can only be made by passengers at the few times on the flight where crew members bring the food trolleys down the aisle, usually around meal times. Paying for meals, therefore, is not uncommon, but has to be done through a flight attendant. There is no automated dispensing of items present.

The dispenser will enhance the passenger experience by providing choice combined with a more hygienic handling system, preventing germ transfer via the food packaging in the confined space of the aircraft. Further, employing the barcode on the boarding pass as a method of retrieval/payment will eliminate the need to deal with purchasing processes involving crew-passenger interaction on board flights. It offers a crew-free purchase process, and hence is less labor intensive. It eliminates the inconvenience of aisles being engaged by the cart being pushed and/or pulled by the crew up and down the aisles. It also reduces the risk of injury by the cart accidentally hitting passengers' hands and/or feet as passengers are seated in the aisle seat or queuing to pass the cart during snack/food servicing in order to access the lavatory, etc. Additionally, the dispenser prevents aisle blockage by trolleys when snacks are served and passengers are attempting to walk down aisles, for example, to access lavatories. Such situations often cause crew members to have to return to galleys with the trolleys mid-way through cabin service, which is inefficient and inconvenient, for both crew and passengers. The dispenser reduces the occurrence of such traffic in the aisles due to cabin service. It also facilitates a safer and more work-friendly environment for the crew to carry out their galley related activities.

### BRIEF DESCRITPION OF DRAWINGS

FIG. 1 shows the current open-box method employed by airlines whereby individually wrapped snacks are placed in a simple cardboard box passengers reach into to retrieve their food.

FIG. 2 shows the front view of a possible design for the dispenser which will house various food snacks and small, contained beverages. It also shows a possible placement for the retrieval space as well as possible mechanisms for payment, a possible position for the display, and a possible position of the key pad.

FIG. 3 shows the side view of a possible design for the dispenser with the power connection port mating with its counterpart in the galley monument.

FIG. 4 shows the side view of a possible design for the dispenser that utilizes a rechargeable battery and shows a possible placement for the battery compartment.

FIG. 5 shows a possible schematic for the electronic box inside the dispenser, which can keep track of stock, snacks claimed/purchased, etc.

FIG. 6 shows the galley monument, which is a possible location for dispenser placement.

### DETAILED DESCRIPTION OF INVENTION

The current self-serve method for distributing refreshments on board aircraft provides no means for monitoring the number of snacks claimed by a single passenger. This creates a situation where some passengers may take more than the airline's planned share of snacks for each passenger while on board the aircraft, leaving little to nothing for other passengers. In the past, this may have led airlines to carry excess food on board. However, having unlimited food supplies on the plane is not a reasonable solution to the problem as it is accompanied by its own disadvantages, such as excess weight on the aircraft, increased cost to the airline, and so on.

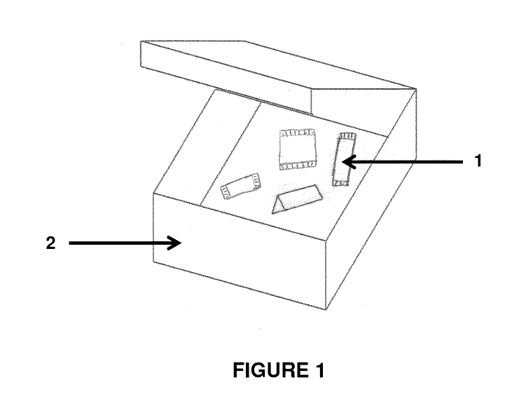

The current open box method, one example shown in FIG. 1, also has no means of preventing passengers from touching snacks they do not intend to take for themselves, allowing them to touch some of the snacks and then leave these snacks for the next passenger. The snacks, although individually wrapped 1, are generally mixed in the open top box 2. The process of picking and choosing could potentially transfer harmful germs from one passenger's hands to the wrapping, and, in turn, to other passengers and/or aircraft personnel.

In terms of “Food for Purchase” on board flights, where meals and snacks are not provided for free, the current method of distribution requires crew to push carts through aisles in order for passengers to purchase food. This is not only labor intensive and time consuming but also limits when passengers are able to purchase the food. It also involves direct exchange of money or credit cards with flight attendants and places the burden of taking stock and tracking purchases upon the flight attendants. In addition, the quantity of food sold on the flight depends on the passengers' willingness to buy the food and there is currently no efficient and effective way to gauge how many passengers are planning on purchasing food, in order to plan ahead accordingly.

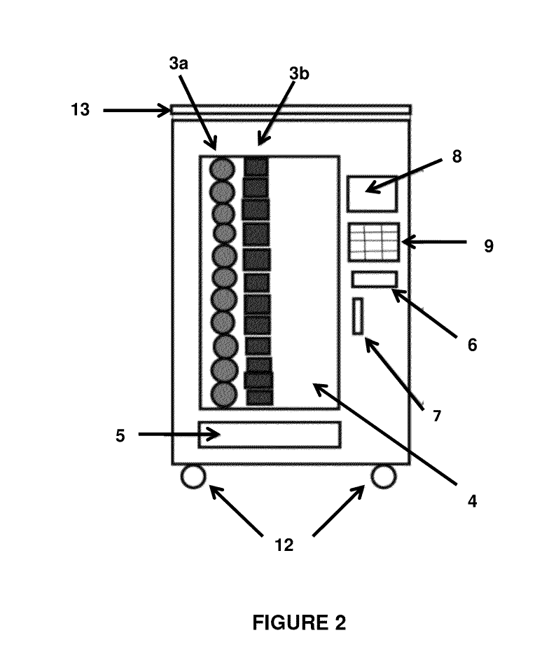

In order to resolve these problems, airlines need a means of distribution that allows greater control of goods and prevents potential hygiene issues. This application, designed for managing snack allowance/food purchase and the method of its retrieval, will be an automated snack dispenser for use mainly onboard aircraft, one example illustrated in FIG. 2, the key users being commercial airlines and/or aircraft manufacturers. However, the use of this product is not limited to airlines and it should be noted that uses in other locations and for other purposes are also possible. Using this dispenser, passengers will be able to access snacks as and when the dispenser is made available and/or activated by the crew. These dispensers will generally be activated between meal periods for flights that provide meals and possibly throughout the entirety of the flight, except during takeoff and landing, for those flights that do not provide food. Here, a good example of availability-time will be similar to that of lavatory access by passengers, which is generally dictated by the status of the flight and flight conditions. Therefore, the dispensers will be disabled during takeoff and landing. However, airlines may also choose to have the dispenser activated before takeoff or at any other time they consider it appropriate and safe to do so.

The dispenser will allow passengers to retrieve a set number of free snacks up to their allowed amount, if this is the airline's preferred method. The retrieval of these free snacks can be achieved by a number of methods, including but not limited to, scanning the barcode from their boarding pass into the reader on the dispenser, scanning a Quick Response (QR) code loaded onto a mobile device (paperless option) or issued on a pass to the passenger, swiping a prepaid card issued by the airline, and/or any other means of identifying the passenger/his or her allowance through the dispenser software. After a passenger has reached this limit, he or she can pay for further snacks. If the flight does not offer complimentary food or a number of free snacks, passengers can pay for snacks/food when the dispenser is available. Therefore, if an airline that does offer free snacks using the dispenser chooses to eliminate its complimentary snack system, the dispenser can still be used to facilitate the purchase of food items.

The method for purchasing food/additional, non-complimentary snacks can be prepaid prior to flight or on demand aboard the aircraft. The prepaid approach would allow passengers to load a credit onto their boarding pass, QR code/mobile app, or prepaid card either in the form of cash or units of refreshment, depending on airline preference. This could be done upon booking, during online check-in or check-in at the airport counter, or any time passengers have access to their booking, either online or in person.

The prepaid option can also be applied to loyalty cards and/or frequent flyer membership cards. With this option, the airlines can choose to offer extra complimentary snacks, which would otherwise be paid for, for a passenger as a token of appreciation.

A purchasable prepaid card from shops in the airport can also be envisaged in the future for use on board various airlines that are furnished with the dispenser unit.

Other outlets for purchasing prepaid credit can also be employed at the airline's preference.

The prepaid method would give the airline an idea of the demand that it will need to fill during the flight, which could save cost and prevent over stocking. The prepaid option could also allow passengers to make a selection or indicate what type of snack they would like to have while on board, allowing the airline to stock more efficiently. This would present a further advantage in “Food for Purchase” flights where it is currently unknown whether passengers will purchase food.

As an alternative to prepaid methods, passengers could also pay for snacks/food directly on board the flight with a credit card, possibly the airline's rewards cards, which they would be able to swipe on the dispenser, or with PayPal.

The passenger will be required to scan his or her boarding pass every time he or she retrieves a snack, whether it is from the free allowance or whether it is a purchased snack using an alternate form of payment, such as a credit card. This will allow airlines to instate an ultimate limit to the number of snacks one passenger can claim, including the additional snacks purchased, across all dispensers on board the aircraft.

The automated and/or semi-automated. dispenser, one example shown in FIG. 2, could have a number of set ups but would generally be a container,/enclosure with a lumber of columns/rows 3a/3b and a means for dispensing the items, eliminating the open box. This could come in the form of simple columns, stacked with the same item with a dispenser at the bottom of each column, where items would “drop” into the retrieval area when they are selected. Additionally and alternatively, the dispenser could have a grid-like setup with rows and columns each containing different items at different coordinates. These items would be dispensed by a mechanism that would effectively push the front-most item in the position selected out of the position where it is held, allowing the item to fall into the retrieval area. Another design could utilize shelves with a number of platforms that revolve around a central axis on demand, when a button is pressed, the purpose being to view all snack options. With the revolving design, there would be a space efficiency element inside the dispenser. The designed enclosure could have various styles, including, but not limited to, a clear, plastic/polycarbonate front panel 4, allowing passengers to view the items inside the dispenser.

The dispenser would have a retrieval space 5 in the appropriate position to allow for the snacks to be dispensed out to the passenger. This retrieval area could be at the bottom of the dispenser, to the side, or any other location on the dispenser, depending on the dispensing mechanism employed by the machine. The dispenser would have a barcode reader 6 so passengers can scan their boarding passes, and/or a QR code reader 6, and/or a slot to slide credit cards 7 and/or prepaid cards 7 and/or loyalty cards 7 to allow passengers to redeem their snacks.

One possible mode of operation is that the dispenser has a digital display screen 8. When the boarding pass is scanned, the display will show how many free items the passenger has left and how much prepaid credit the passenger has available, if any. Swiping a prepaid card or scanning a QR code or any of the other types of retrieval methods will prompt this display. The passenger will then enter the code of the item he or she wants to retrieve on the dispenser key pad 9.

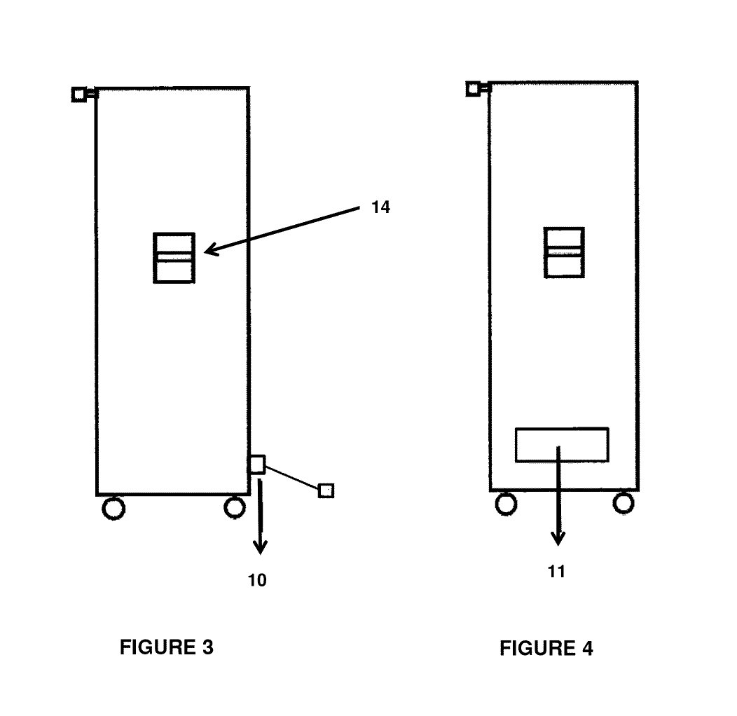

The dispenser, two possible examples shown in FIGS. 3 and 4, respectively, will operate using an electric power line 10 supplied by the aircraft's power and/or via a rechargeable battery 11, respectively. It is anticipated that the power consumption by the dispenser will be very low either way.

Considering the types of snacks available in the dispenser would be largely nonperishable, refrigeration would not be a necessity, again reducing the needed power supply from the airplane to the dispenser in the plug in version. However, airlines may choose to upgrade the dispenser in order to dispense food/sandwiches that need to be chilled. With this upgraded version, existing galley air chillers on board aircraft may be utilized.

The dispenser would be made of a light weight material, such as a polymer/plastic and/or composite based material that is approved for use on the aircraft interior, to minimize any additional weight. The nominal size of the dispenser would be compatible with the size of a. food trolley. However, size could vary depending on the location of the dispenser and the airline's preference.

The dispenser design, one example shown in FIG. 2, could include wheels 12 on the bottom of the enclosure and a handle 13 at the top to allow for easier transportation on and off the aircraft for restocking and/or exchange for a filly stocked unit in preparation. for the next flight. This can also speed up aircraft turn-around time in relation to time taken currently to bring food on board.

Replenishing the supplies in the dispenser can be done by a number of methods. The dispenser could be restocked by loading items into the dispenser that is fixed in a pre-allocated space on board the aircraft within the galley confinement. In this method, the dispenser does not need to be removed from its location for refilling in contrast to a version which is mobile. The enclosure would have a panel that can be opened (location may vary depending on placement and airline preference) to allow restocking. Restocking could be done by individually replacing each of the snacks or by having prepackaged columns that can be inserted into the dispenser as a whole, depending on the variety of dispenser designs previously outlined.

A different method for restocking could involve replacing the dispenser as a whole with another filly stocked dispenser at the airport during turn around and/or refueling for the next flight. For this method, the dispenser will have wheels like those on food serving trolleys and/or trash compactor/collector trolleys, which are secured in a pre-designated space/location in the galley by manually activating the brake mechanism and locking it to the monument with a possible latch mechanism 14 (placement of latch can be varied). This will allow the dispenser to be easily rolled out/in for replacement and also allow for secure placement during the flight.

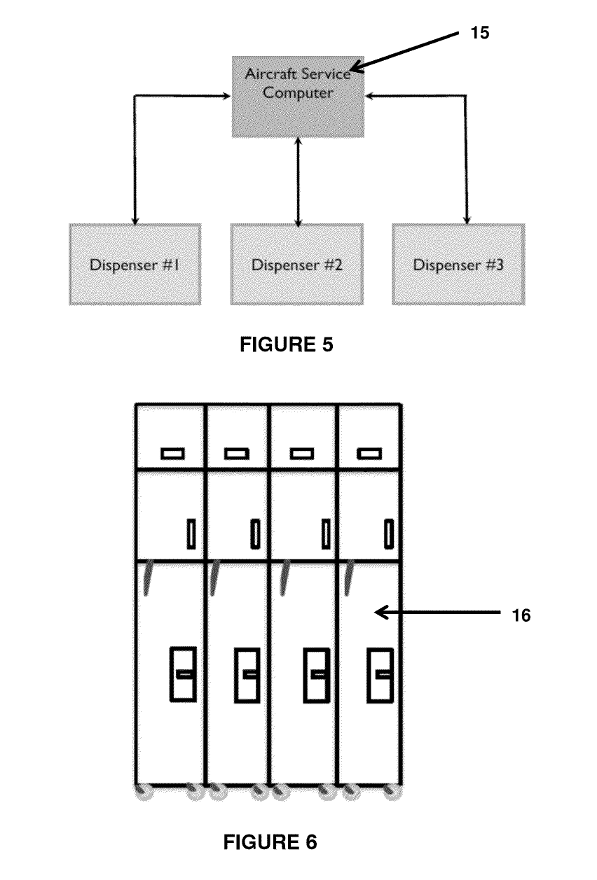

Restocking would be made simpler by the electronic control box that is part of the dispenser, of which one example of a schematic is shown in FIG. 5. This electronic control box containing a non-volatile memory and/or equivalent will be able to store/record data on what snacks are dispensed and in what quantity, essentially keeping stock of the refreshments on board. It will communicate 15 with the aircraft service computer and/or other data management. systems and will electronically indicate the status and availability of food in the dispenser. This will allow for the message/order to be passed to the next landing port prior to landing, facilitating the recharging of the dispenser at the next refilling station. The electronic control box and its centralized control system will also allow for each dispenser to indicate to the passenger if it is stocked with the passengers selection and, if needed, indicate a different dispenser where the passenger can retrieve their desired snack depending on aircraft interior configuration and number of galleys and services avaitabile.

The location of the dispenser, one example of which is shown in FIG. 6, while primarily in the galley 16, could vary depending on aircraft type and interior cabin configuration. The area currently occupied by the food trolley and any unused space behind it can be shared. between the food/snack dispenser and/or the number of trolleys can be reduced to make room for the snack/food dispenser. One example of an arrangement can be that the space for the traditional food trolley is interchangeable with the snack/food dispenser, where both are stored in tandem in the same compartment, allowing one to be moved to the front and the other to the back pending the food and snack service program on board the aircraft. This arrangement can also safeguard the current trolley arrangement and allow airlines to choose which food service is most needed for a given flight route and destination.

What is claimed is:

1. A dispenser configuration comprised of:
a) A light-weight structural body in compliance with aircraft hardware standards with an interior that contains rows and columns that are arranged to house pre-packed/individually wrapped wrapped food/snacks.
b) The light-weight structural body claimed in part is in compliance with aircraft electrical standards for the supply of electrical power and/or electrical source of energy for the operation of the dispenser.
c) The light-weight structural body claimed in part a) is in compliance with aircraft software standards for operating the dispenser with input/output data and data acquisition.

2. The dispenser in claim 1, further being comprised of an internal power-on and off switch.

3. The dispenser in claim 1, further being comprised of a partial and/or full front-face see-through panel.

4. The dispenser in claim 1, further having wheels and latches.

5. The dispenser in claim 1, further including a scanner for barcodes (i.e. on boarding passes) and/or QR codes for dispensing food and tracking passenger retrievals, or equivalent.

6. The dispenser in claim 1, further including a magnetic and/or digital card reader, or equivalent.

7. The dispenser in claim 1, further having a connector/port to aircraft maintenance/service computer or means for wireless connection.

8. The dispenser in claim 1, further including a digital message display screen/window.

9. The dispenser in claim 1, further comprising a mechanism for delivering pre-packed/wrapped snack/food without handling by passengers/crew.

10. The dispenser in claim 1, further comprising a microprocessor mechanism for managing preprogrammed distribution of the snacks/food evenly per passenger per allowed allocation.

11. The dispenser in claim 1, further comprising a mechanism to purchase snack/food by passengers pending pre-programed allocation.

12. The dispenser in claim 1, further comprised of a mechanism allowing crew to power on and off the dispenser per aircraft operational instructions/procedure and service availability times to passengers during flight, where service availability times can also be announced by crew and/or be given in printed information such as the airline magazine in the seat pocket or, equally, displayed on an in-flight entertainment system.

13. The dispenser in claim 1, further comprised of a mechanism for transmitting food/snack availability status and utilization level to aircraft maintenance computer for reloading and/or replacing the dispenser box at the next stop.

14. The dispenser in claim 1, further comprising a mechanism for withdrawing snack/food without exchange of cash.

15. The dispenser in claim 1, further comprised of a mechanism for accepting prepaid charge card and/or boarding pass with credit line.

16. The dispenser in claim 1, further allowing food dispersal without direct crew assistance.

17. The dispenser in claim 1, facilitating a more hygienic method of snack and food access by eliminating undesired handling both by passengers as well as crew.

18. The dispenser in claim 1, facilitating less disruptive food access onboard the aircraft and reducing the risk of passengers and/or the crew corning into harm by accidently being hit with the food trolley/cart during the food service.

19. The dispenser in claim 1, facilitating a more user friendly environment for both crew and passengers, especially for the crew by making it unnecessary for the crew to push and pull the trolley/cart along the length of the aircraft cabin for dispensing snacks/food.
